(19) United States
(12) Patent Application Publication
(10) Pub. No.: US 2015/0156157 A1
(43) Pub. Date: Jun. 4, 2015

(54) ASSOCIATION METHOD AND DEVICE FOR COMMUNICATIONS MODES

(71) Applicant: TENCENT TECHNOLOGY (SHENZHEN) COMPANY LIMITED, Shenzhen, Guangdong (CN)

(72) Inventors: Xiaolong Zhang, Shenzhen (CN); Tieming Huang, Shenzhen (CN); Wenjie Zhou, Shenzhen (CN)

(21) Appl. No.: 14/415,941

(22) PCT Filed: Jul. 19, 2013
(86) PCT No.: PCT/CN2013/079725

§ 371 Date: Jan. 20, 2015

(30) Foreign Application Priority Data
Jul. 20, 2012 (CN) 201210252141.3

(51) Int. Cl. H04L 12/58

(52) U.S. Cl. CPC H04L 51/22; H04L 51/04

(57) ABSTRACT

Disclosed are an association method and device for communication modes, the method comprising: receiving a first operation instruction, the first operation instruction being used for instructing the establishment of an association of identification numbers in a first Internet application; responding the first operation instruction, and acquiring a first identification number of a first e-mail box and a second identification number of a second e-mail box; establishing an association between the first identification number and the second identification number in the first Internet application.

### TECHNICAL FIELD

The present invention relates to the field of communications, and in particular to an association method and device for communication modes.

### TECHNICAL BACKGROUND

With the development of the Internet, more and more applications are available for a user, and the user may have various identifiers for various types of applications. In an application such as QQ, the user can have a friend group relationship, while in another application such as Wechat, the user can have another friend group relationship.

Generally, only if using a Wechat client program, a Wechat user can perform an operation of adding other Wechat users into a contact list or greeting other Wechat users. That is, without the Wechat client program, the Wechat user cannot build, via another application, a friend relationship in Wechat or greet other Wechat users through Wechat. Similarly, only if using an instant messenger (such as QQ) client program, an instant messenger user can add other instant messenger users as friends in the instant messenger. That is, without the instant messenger client (such as QQ) program, the instant messenger user cannot build, via another application, a friend relationship with other instant messenger users through the instant messenger (such as QQ).

Currently, a traditional e-mail box, which can provide a function of receiving and transmitting an e-mail for a user, has become an important communication tool among people, and many users communicate with each other through e-mails. However, currently the e-mail box cannot be used to extend friend relationships in other applications (such as, QQ and Wechat) for the users, that is, a recipient or a sender of an e-mail cannot be added as a friend in QQ or Wechat by the current e-mail box, which prevents the user from better extending the friend relationship of the user.

Therefore, there is a need to provide a new technical solution to solve the above problem.

### SUMMARY

Embodiments of the present invention provides an association method and device for communication modes, which can establish an association between the two communication parties of the e-mail in other Internet applications (for example, establish a relationship in Wechat) based on the e-mail communication.

In order to solve the above problem, technical solutions of embodiments of the present invention are set forth as follows.

An association method for communication modes, including: transmitting and receiving an e-mail between a first e-mail box and a second e-mail box; acquiring a first identifier corresponding to the first e-mail box and a second identifier corresponding to the second e-mail box; determining whether to associate the first identifier and the second identifier; and associating the first identifier and the second identifier if it is determined to associate the first identifier and the second identifier.

An association device for communication modes, including: an e-mail reception and transmission module, which is configured for receiving and transmitting an e-mail between a first e-mail box and a second e-mail box; a second acquisition module, which is configured for acquiring a first identifier corresponding to the first e-mail box and a second identifier corresponding to the second e-mail box; a second determination module, which is configured for determining according to the first identifier and the second identifier whether to associate the first identifier and the second identifier; and an association module, which is configured for associating, if it is determined by the second determination module to associate the first identifier and the second identifier, the first identifier with the second identifier.

An identifier association establishing method, including: receiving a first operation instruction transmitted by a first e-mail box, wherein the first operation instruction is generated by the first e-mail box according to a click operation by a user, and the first operation instruction is configured for instructing establishment of an association between identifiers in a first Internet application; acquiring a first identifier and a second identifier in response to the first operation instruction, wherein the first identifier is an identifier of the first e-mail box, and the second identifier is an identifier of the second e-mail box in communication with the first e-mail box; and establishing an association between the first identifier and the second identifier in the first Internet application.

An identifier association establishing device, including: an operation instruction reception module, which is configured for receiving a first operation instruction transmitted by a first e-mail box, wherein the first operation instruction is generated by the first e-mail box according to a click operation by a user, and the first operation instruction is configured for instructing establishment of an association between the identifiers in a first Internet application; a first acquisition module, which is configured for acquiring a first identifier and a second identifier in response to the first operation instruction, wherein the first identifier is an identifier of the first e-mail box, and the second identifier is an identifier of the second e-mail box communicated with the first e-mail box; and an identifier association establishing module, which is configured for establishing an association between the first identifier and the second identifier in the first Internet application.

### BENEFITS EFFECTS

The present invention can establish an association between the two communication parties of the e-mail in other Internet applications (for example, establish the friend relationship in Wechat) based on the e-mail communication as compared with the prior art.

### DESCRIPTION OF DRAWINGS

FIG. 1 is a block diagram showing an association device for communication modes according to an embodiment of the present invention;

FIG. 2 is a block diagram showing an association module in FIG. 1;

FIG. 3 is a flowchart showing an association method for communication modes according to an embodiment of the present invention;

FIG. 4 is a flowchart showing a step of associating two communication parties in FIG. 3;

FIG. 5 is a block diagram showing an identifier association establishing device according to an embodiment of the present invention;

FIG. 6 is a block diagram showing an identifier association establishing module in FIG. 5;

FIG. 7 is a flowchart showing an identifier association establishing method according to an embodiment of the present invention; and

FIG. 8 is a flowchart showing a step of establishing an association between a first identifier and a second identifier in a first Internet application according to the method in FIG. 7.

### DETAILED DESCRIPTION OF THE PREFERRED EMBODIMENT

Various embodiments below are illustrated with reference to accompanying drawings to illustrate the implementation of specific embodiments of the present invention.

In the illustration below, the specific embodiments of the present invention are illustrated with reference to reference numerals and steps executed by one or more computers or mobile devices, unless otherwise stated. Therefore, as mentioned for a number of times below, it may be understood that these steps and operations may be performed by the computer or mobile device including respective processing units, which are configured for manipulating (i.e. processing) an electronic signal having a particular data structure. The manipulation can convert the electronic signal or maintain the electronic signal at a particular position in a memory of the computer or mobile device, and can reconfigure or otherwise change operations of the computer or mobile device in a manner known by those skilled in the art. The data structure maintained by the electronic signal is stored at a physical position in the memory, and the electronic signal has a specific feature defined by the data structure. However, the principle of the present invention is not limited to the above illustration, and those skilled in the art will recognize that various steps and operations described below can also be implemented in hardware.

The principle of the present invention can be embodied with many other general or particular computations, communication environments or configurations. Well known examples applicable to the computation system, the environment and the configuration according to embodiments of the invention can include, but not limited to, a tablet computer, a mobile phone, a personal computer, a server, a multi-processor system, a micro-computer based system, a mainframe computer and a distributed computation environment, in which any one of the above systems or devices is included.

As used herein, the term “module” or “unit” may refer to a software object or a routine executed in the computation system. The various components, modules, engines and services described herein can be implemented as objects or processes executed in the computation system. The system or method described herein is preferably implemented as software, but the implementation thereof by hardware or combination of hardware and software may also be possible and taken into consideration.

An identifier association establishing method and device or an association method and device for communication modes can be operated in a computer or mobile device. The computer can be a system composed of one or more of a personal computer, a server and so on. The mobile device can be a system composed of one or more of a tablet computer, a mobile phone, a Personal Digital Assistant (PDA), a laptop and so on. The computer or mobile device can include any combination of a processor, a memory, a sensor, a switch device, a supply source, a clock signal generator, an input and output device and so on. Any combination of a processor, a memory, a sensor, a switch device, a supply source, a clock signal generator, an input and output device and so on in the computer or mobile device is used for implementing steps of the method and functions of the device according to embodiments of the present invention.

In the embodiment, software program instructions corresponding to the device are stored in the memory, and executed by the processor to realize a process management of an operation system.

In addition, the above memory may be a computer readable storage medium, which can be a magnetic disk, an optical disk, a read-only memory (ROM) or a random access memory (RAM), for example.

An association device for communication modes according to an embodiment of the present invention may be a server, or may be integrated into a server, or may act as a server, or may also be a client program on a user equipment. Accordingly, an association method for communication modes can be performed in the server or a device similar to the server, or can be also operated by the client program on the user equipment.

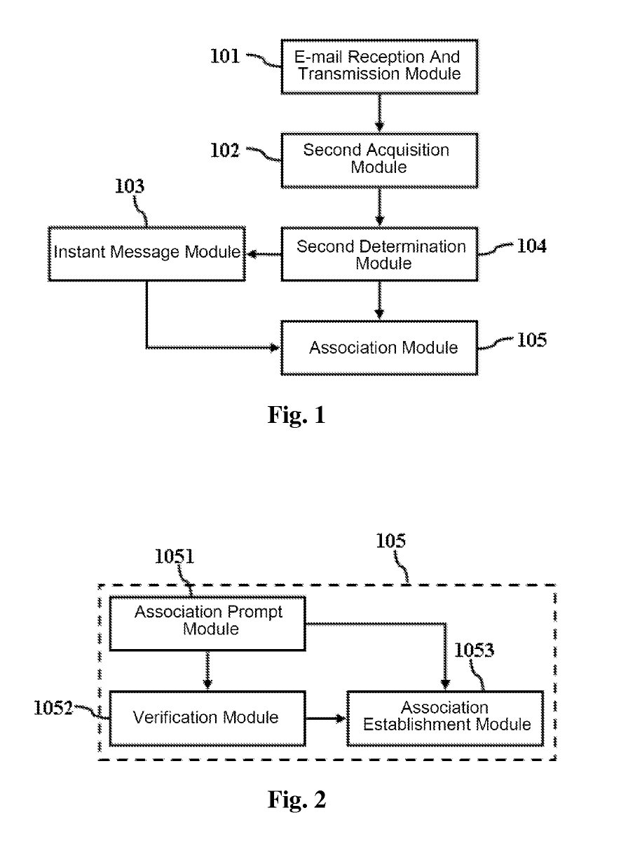

Referring to FIG. 1 which is a block diagram showing a structure of a preferred embodiment of an association device for communication modes according to an embodiment of the present invention, the association device may be a server. In the present embodiment of the invention, a first communication party and a second communication party communicate with each other by means of the association device for communication modes according to the embodiment of the present invention. The association device for communication modes according to the embodiment of the present invention includes an e-mail reception and transmission module 101, a second acquisition module 102, a second determination module 104, an association module 105 and an instant messaging module 103.

The e-mail reception and transmission module 101 is configured for transmitting and receiving an e-mail between the first communication party and the second communication party, where the first communication party has a first e-mail box and the second communication party has a second e-mail box. The e-mail reception and transmission module 101 is configured for the e-mail reception and transmission between the first e-mail box and the second e-mail box. The second acquisition module 102 is configured for searching for a first identifier corresponding to the first e-mail box of the first communication party according to the first e-mail box, and searching for a second identifier corresponding to the second e-mail box of the second communication party according to the second e-mail box. The first identifier and the second identifier each may be an instant messenger account of a user, such as a QQ account, and may also be a Wechat account, a cellphone number and so on.

The second determination module 104 is configured for determining, according to the first identifier and the second identifier, whether to associate the first identifier and the second identifier, that is, for determining a relationship between the first communication party and the second communication party, to obtain a determination result which may be either a first case where relationships such as a QQ friend relationship (i.e. an association in a QQ application) and a Wechat friend relationship (i.e. an association in a Wechat application) are present between the first communication party and the second communication party and thus it is determined not to associate the first identifier and the second identifier again, or a second case where any one or more of the relationships such as the QQ friend relationship and the Wechat friend relationship are not present between the first communication party and the second communication party and thus it is determined to associate the first identifier and the second identifier.

The association module 105 is configured for extending the relationship between the first communication party and the second communication party according to the above determination result. That is, if all of the QQ friend relationship, the Wechat friend relationship and so on are present between the first communication party and the second communication party, it is determined not to associate the first identifier and the second identifier again, and thus the association module 105 does not extend the relationship between the first communication party and the second communication party, that is, the association module 105 does not associate the first identifier with the second identifier. On the contrary, if any one or more than one of the QQ friend relationship, the Wechat friend relationship and so on is not present between the first communication party and the second communication party, it is determined to associate the first identifier and the second identifier, and thus the association module 105 extends the relationship such as the QQ friend relationship and the Wechat friend relationship between the first communication party and the second communication party, that is, the association module 105 associates the first identifier with the second identifier.

The instant messaging module 103 is configured for transmitting and receiving an instant message between the first e-mail box and the second e-mail box, that is, in response to an operation at any one of the first communication party and the second communication party, the one of the first communication party and the second communication party transmits the instant message to or receives the instant message from the other of the first communication party and the second communication party for the sake of instant communication between the first communication party and the second communication party, so that the association module 105 extends the association between the first communication party and the second communication party, i.e. associates the first identifier with the second identifier.

Reference is made to FIG. 2, which is a block diagram showing the association module 105 of FIG. 1. The association module 105 includes an association prompt module 1051. The association prompt module 1051 is configured for generating association prompt information according to the above determination result if it is determined to associate the first identifier and the second identifier, and transmitting the association prompt information to either of the first communication party and the second communication party, for example, to prompt the first communication party whether to add the second communication party as a friend such as a Wechat friend, a QQ friend and so on. The association prompt module 1051 is further configured for displaying the relationship existing between the first communication party and the second communication party, i.e. displaying the association between the first identifier and the second identifier if such association between the first identifier and the second identifier exists, for example, displaying a Wechat friend relationship, a QQ friend relationship and so on between the first communication party and the second communication party.

The association module 105 further includes an association establishment module 1053. For example, if the association prompt information is accepted by the first communication party, the association establishment module 1053 establishes a relationship such as a QQ friend relationship and a Wechat friend relationship between the first communication party and the second communication party, i.e. establishing an association between the first identifier and the second identifier, according to the association prompt information. Before establishing the association between the first identifier and the second identifier, the association establishment module 1053 may further transmit an association establishment request to the second communication party, and if the association establishment request is accepted by the second communication party, then the association establishment module 1053 establishes the association between the first identifier and the second identifier; otherwise, it is regarded that the first communication party is in a blacklist of the second communication party, and thus the association establishment module 1053 does not attempt to establish the association between the first identifier and the second identifier.

The association module 105 further includes a verification module 1052. The verification module 1052 is configured for transmitting verification information to the second communication party if the association prompt information is accepted by the first communication party, in order to provide the verification information to the second communication party for verifying, and further receiving a verification result from the second communication party. The association establishment module 1053 is further configured for establishing the relationship between the first communication party and the second communication party, i.e. establishing the association between the first identifier and the second identifier, if the verification result is correct.

In the case that the association prompt information is accepted by the first communication party, if the second communication party requests for verifying the first communication party, then the verification module 1052 verifies the verification information from the first communication party; and if the second communication party does not request for verifying the first communication party, then the association establishment module 1053 directly establishes the relationship between the first communication party and the second communication party, that is, establishes the association between the first identifier and the second identifier, according to the association prompt information.

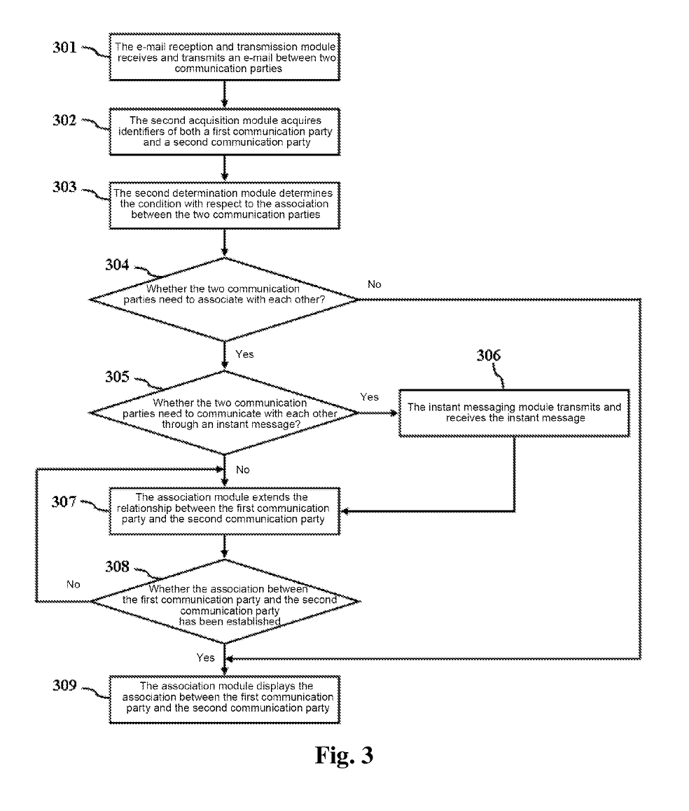

Reference is made to FIG. 3 which is a schematic flowchart of a preferred embodiment of an association method for communication modes according to an embodiment of the present invention. The method may be performed by the association device for communication modes according to the embodiment of the present invention, where the association device for communication modes may be set in a server, a terminal of the first communication party, or a terminal of the second communication party, and may also be set in both terminals of the first communication party and the second communication party. The association device for communication modes according to the embodiment of the present invention includes an e-mail reception and transmission module 101, a second acquisition module 102, a second determination module 104, an association module 105 and an instant messaging module 103.

At Step 301 of the method, the e-mail reception and transmission module 101 implements the reception and transmission of an e-mail between the first communication party and the second communication party, where the first communication party has a first e-mail box address and the second communication party has a second e-mail box address. The first communication party is in communication with the second communication party via the first e-mail box, and the second communication party is in communication with the first communication party via the second e-mail box.

At Step 302 of the method, the second acquisition module 102 searches for a first identifier corresponding to the first e-mail box according to the first e-mail box and searches for a second identifier corresponding to the second e-mail box according to the second e-mail box, where the first e-mail box and the second e-mail address each may be an instant messenger account of a user, such as a QQ account, and may also be a cellphone number of the user, a Wechat account of the user, and so on.

At Step 303 of the method, the second determination module 104 determines, according to the first identifier and the second identifier, whether to associate the first identifier and the second identifier, i.e. determines a relationship between the first communication party and the second communication party, to obtain a determination result which may be either a first case where relationships such as a QQ friend relationship and a Wechat friend relationship are present between the first communication party and the second communication party and thus it is determined not to associate the first identifier and the second identifier again, or a second case where any one or more of the relationships such as the QQ friend relationship and the Wechat friend relationship are not present between the first communication party and the second communication party and thus it is determined to associate the first identifier and the second identifier.

At Step 304 of the method, the second determination module 104 determines whether there is a relationship to be extended between the first communication party and the second communication party, i.e. whether the above determination result is in the second case; and if so, Step 305 is performed to further perform an determination as described later; otherwise, Step 309 is performed. If a relationship such as a QQ friend relationship and a Wechat friend relationship is present between the first communication party and the second communication party, the association prompt module 1051 of the association module 105 displays such relationship, i.e. an association present between the first identifier and the second identifier, if available, is displayed by the association prompt module 1051 of the association module 105.

At Step 305 of the method, the second determination module 104 further determines whether the first communication party and the second communication party need to communicate with each other through an instant message, and if so, Step 306 is performed; otherwise, Step 307 is performed. The determination by the second determination module 104 is based on whether the user (such as the first communication party) chooses the function of transmitting an instant message to the other communication party.

At Step 306 of the method, the instant messaging module 103 transmits and receives the instant message between the first communication party and the second communication party, i.e., in response to an operation at any one of the first communication party and the second communication party, the one of the first communication party and the second communication party transmits the instant message to or receives the instant message from the other of the first communication party and the second communication party. When the transmitter of the instant message (which may be any one of the first communication party and the second communication party) receives a reply from the receiver (which is the other of the first communication party and the second communication party) after transmitting the instant message, the association module 105 establishes the relationship between the first communication party and the second communication party, i.e. establishes the association between the first identifier and the second identifier.

At Step 307 of the method, the association module 105 extends the relationship (such as a QQ friend relationship and a Wechat friend relationship) between the first communication party and the second communication party, i.e. the association module 105 establishes the association between the first identifier and the second identifier.

At Step 308 of the method, the second determination module 104 determines whether the association module 105 has extended the relationship (such as a QQ friend relationship and a Wechat friend relationship) between the first communication party and the second communication party, i.e. whether the association between the first identifier and the second identifier has been established, and if so, the method is ended; otherwise, a further association between the first identifier and the second identifier (that is, there is an additional relationship to be extended between the first communication party and the second communication party) needs to be established, and the method returns to Step 307.

At Step 309 of the method, the association prompt module 1051 of the association module 105 displays the association between the first identifier and the second identifier, if available.

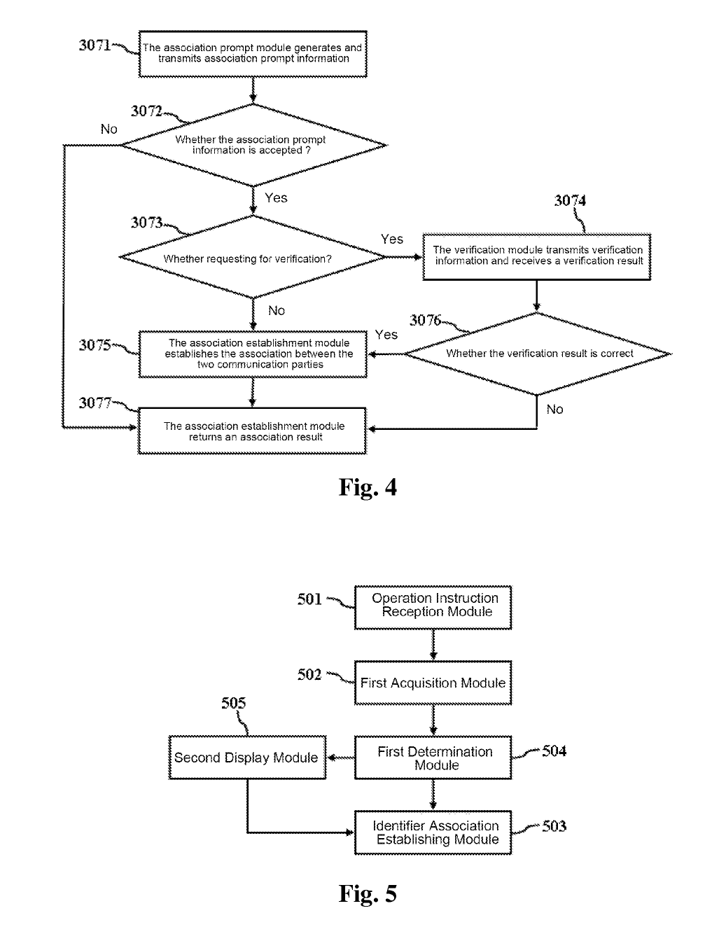

Reference is made to FIG. 4 which is a flowchart showing a step of associating the first communication party and the second communication party by the association module 105.

At Step 3071, the association prompt module 1051 generates association prompt information according to the determination result of the second determination module 104, in the case that it is determined to associate the first communication party and the second communication party, and transmits the association prompt information to at least one of the first communication party and the second communication party.

At Step 3072, the association prompt module 1051 determines whether the association prompt information is accepted by one of the first communication party and the second communication party (for example, by the first communication party), and if so, Step 3073 is performed; otherwise, Step 308 is performed.

At Step 3073, the verification module 1052 or the second determination module 104 determines whether the other of the first communication party and the second communication party (for example, the second communication party) requests for verification, and if so, Step 3074 is performed; otherwise, Step 3075 is performed.

At Step 3074, if the association prompt information is accepted by the first communication party, the verification module 1052 transmits verification information to the second communication party, and receives a verification result transmitted by the second communication party. If the association prompt information is accepted by the second communication party, and if the verification information transmitted by the second communication party is received by the first communication party, then the verification module 1052 verifies the verification information transmitted by the second communication party, and transmits the verification result to the second communication party.

At Step 3076, the verification module 1052 or the second determination module 104 determines whether the verification result is correct, and if so, Step 3075 is performed; otherwise, Step 308 is performed.

At Step 3075, if the association prompt information is accepted by the first communication party and the second communication party does not request for the verification, the association establishment module 1053 establishes the relationship between the first communication party and the second communication party, i.e. the association establishment module 1053 associates the first identifier with the second identifier; or if relationship recommendation information is accepted by the first communication party and the first communication party passes the verification performed by the verification module 1052, the association establishment module 1053 establishes the relationship between the first communication party and the second communication party, i.e. the association establishment module 1053 associates the first identifier with the second identifier. Before the association establishment module 1053 establishes the association between the first communication party and the second communication party, the second determination module 104 determines whether the first communication party is placed in a blacklist (such as a QQ blacklist or a Wechat blacklist) by the second communication party, and if so, the association establishment module 1053 does not extend the relationship (such as a QQ friend relationship and a Wechat friend relationship) between the first communication party and the second communication party, i.e. does not associate the first identifier with the second identifier; otherwise, the association establishment module 1053 extends the relationship (such as the QQ friend relationship and the Wechat friend relationship) between the first communication party and the second communication party, i.e. establishes the association between the first identifier and the second identifier. The determination by the second determination module 104 is based on whether an association establishment request transmitted to the second communication party is rejected before the association establishment module 1053 establishes the association between the first identifier and the second identifier.

At Step 3077, the association establishment module 1053 returns an association result.

In an embodiment of the present invention, a computer program configured for performing the association method for communication modes is stored in a computer storage medium, i.e. the computer program can include program instructions which cause a computer to perform the function of communication mode association, and the function includes Steps 301 to 309 described as above.

Since the association module 105 is provided in the association method and device for communication modes according to an embodiment of the present invention, the association method and device for communication modes according to the embodiment of the present invention can extend a relationship between the two communication parties of an e-mail, i.e. associate the first identifier and the second identifier. For example, if there is not a QQ friend relationship between the first communication party and the second communication party, the relationship between the first communication party and the second communication party may be extended to include the QQ friend relationship therebetween, and if there is not a Wechat friend relationship between the first communication party and the second communication party, the relationship between the first communication party and the second communication party may be extended to include the Wechat friend relationship therebetween, thus facilitating a user to establish the friend relationship with more persons and communicate with more friends. Additionally, since the relationship between two communication parties of the e-mail is determined by the second determination module 104, the relationship between the two communication parties of the e-mail is more effectively acquired, so that the association module 105 can extend a relationship between the user (one of the two communication parties) and another party (the other of the two communication parties) in communication, i.e. associate the first identifier and the second identifier. Therefore, with the association method and device for communication modes according to the embodiment of the present invention, a relationship between the two communication parties of the e-mail can be extended if it is determined to extend the relationship, thereby efficiently extending the relationship of the user in various applications. The instant messaging module 103 enables the user to greet the other communication party, thereby facilitating the extension of the relationship of the user by the association module 105. In the association method and device for communication modes according to the embodiment of the present invention, the association prompt module 1051 can generate association prompt information according to a relationship between the user and another person, and indicate and recommend any relationship extendable to the user, thus facilitating the extension of the relationship of the user. With the association establishment module 1053, the association module 105 in the association method and device for communication modes according to the embodiment of the present invention is configured to extend the relationship between both communication parties of an e-mail to include a relationship such as a QQ friend relationship and a Wechat friend relationship therebetween, i.e. associate the first identifier and the second identifier, if the relationship such as the QQ friend relationship and the Wechat friend relationship is not present between the both communication parties. In addition, the verification module 1052 can verify the requesting party in extending the relationship, thus ensuring accuracy and security for the extension operation of the relationship.

An identifier association establishing device and method according to the embodiment of the present invention may be operated in a client program (a terminal) application on a user equipment or a device similar to the user equipment, and may also be operated in a server.

Reference is made to FIG. 5, which is a block diagram showing an identifier association establishing device according to an embodiment of the present invention.

In an embodiment of the present invention, the association between the identifiers in an Internet application may include a QQ friend relationship, a Wechat friend relationship, a Twitter friend relationship, a Fetion friend relationship, and so on. In an embodiment of the present invention, for example, an association in a first Internet application is a Wechat friend relationship, and an association in a second Internet application is a QQ friend relationship.

An identifier association establishing device according to the present embodiment includes an operation instruction reception module 501, a first acquisition module 502 and an identifier association establishing module 503.

The operation instruction reception module 501 is configured for receiving a first operation instruction transmitted by a first e-mail box, and the first operation instruction is generated by the first e-mail box according to a click operation by a user, and instructs the establishment of an association between identifiers in the first Internet application.

The first acquisition module 502 is configured for acquiring a first identifier and a second identifier in response to the first operation instruction, where the first identifier is an identifier of the first e-mail box and the second identifier is an identifier of the second e-mail box in communication with the first e-mail box. For example, the first acquisition module 502 searches for the first identifier corresponding to the first e-mail box of the first communication party according to the first e-mail box, and searches for the second identifier corresponding to the second e-mail box of the second communication party according to the second e-mail box. The first identifier and the second identifier each may be an instant messenger account of a user, such as a QQ account, and may also be a Wechat account, a cellphone number, and so on. In the present embodiment, the first identifier and the second identifier are QQ accounts corresponding to the e-mail boxes, for example.

The identifier association establishing module 503 is configured for establishing an association between the first identifier and the second identifier in the first Internet application, based on the first identifier and the second identifier.

Preferably, the identifier association establishing device further includes a first determination module 504.

The first determination module 504 is configured for determining whether there is an association between the first identifier and the second identifier in the first Internet application and in the second Internet application, respectively, and generating a determination result. The determination result includes three cases, i.e. a first case where an association is present between the first identifier and the second identifier in the first Internet application, a second case where an association is present between the first identifier and the second identifier in the second Internet application rather than in the first Internet application, and a third case where no association is present between the first identifier and the second identifier in either the first Internet application or the second Internet application.

The identifier association establishing module 503 is configured for establishing the association between the first identifier and the second identifier in the first Internet application according to the determination result.

As an improvement for the identifier association establishing device according to the present embodiment, the identifier association establishing device further includes a second display module 505.

The second display module 505 is configured for displaying prompt information if the determination result shows that an association is present between the first identifier and the second identifier in the first Internet application, where the prompt information corresponds to the case that there is an association between the first identifier and the second identifier in the first Internet application, which is advantageous for enabling the user to be aware of the association between the first identifier and the second identifier in the first Internet application.

The identifier association establishing device according to an embodiment of the present invention can establish an association between the two communication parties of the e-mail in other Internet applications (for example, establish the friend relationship in Wechat) based on the e-mail communication.

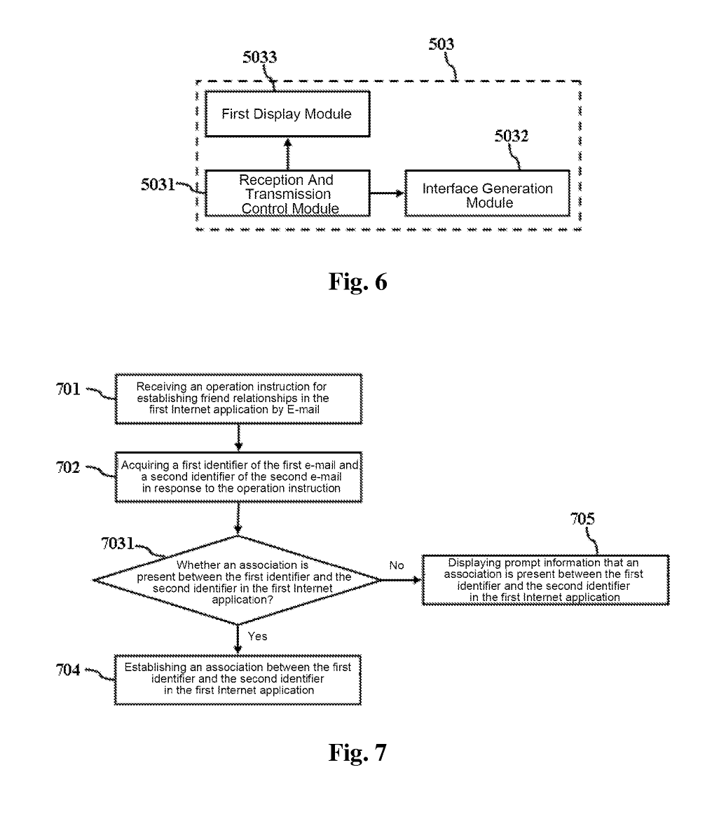

Reference is made to FIG. 6, which is a block diagram showing an identifier association establishing module 503.

In the identifier association establishing device according to the present embodiment, the identifier association establishing module 503 includes a reception and transmission control module 5031 and a first display module 5033.

If an association is present between the first identifier and the second identifier in the second Internet application rather than in the first Internet application, the reception and transmission control module 5031 is configured for: transmitting request information via the first e-mail box, with the request information being used for requesting to establish the association between the first identifier and the second identifier in the first Internet application; and receiving result information via the first e-mail box, with the result information being used for returning an result of the establishment of the association between the first identifier and the second identifier in the first Internet application. In particular, the reception and transmission control module 5031 is configured for transmitting the request information to a server for the first Internet application via the first e-mail box and receiving feedback information (i.e. result information) corresponding to the request information from the server of the first Internet application via the first e-mail box.

The first display module 5033 is configured for displaying the result information.

As an improvement for the above identifier association establishing device, the reception and transmission control module 5031 is further configured for receiving verification request information via the first e-mail box.

The identifier association establishing module 503 further includes an interface generation module 5032.

The interface generation module 5032 is configured for generating and displaying a verification content inputting interface.

The reception and transmission control module 5031 is further configured for transmitting, via the first e-mail box, verification content information inputted by a user. In the present embodiment, the identifier association establishing module 503 transmits request information for establishing an association between the first identifier and the second identifier in the first Internet application to the server of the first Internet application, so as to establish the association between the first identifier and the second identifier in the first Internet application.

If no association is present between the first identifier and the second identifier in either the first Internet application or the second Internet application, the interface generation module 5032 is further configured for generating and displaying a greeting content inputting interface.

The reception and transmission control module 5031 is further configured for transmitting, via the first e-mail box, greeting content information inputted by a user. In particular, the reception and transmission control module 5031 is configured for transmitting the greeting content information to the server of the first Internet application via the first e-mail box. In the present embodiment, the identifier association establishing module 503 transmits the greeting content to an account corresponding to the second identifier in the first Internet application to establish the association between the first identifier and the second identifier in the first Internet application.

Reference is made to FIG. 7, which is a flowchart showing an identifier association establishing method according to an embodiment of the present invention.

In the embodiment of the present invention, the association between the identifiers in the Internet application may include a QQ friend relationship, a Wechat friend relationship, a Twitter friend relationship, a fetion friend relationship, and so on. In the embodiment of the present invention, for example, the association in a first Internet application is a Wechat friend relationship, and the association in a second Internet application is a QQ friend relationship.

An identifier association establishing method according to the present embodiment includes Steps 701 to 705 below.

At Step 701, the operation instruction reception module 501 receives a first operation instruction transmitted by a first e-mail box, where the first operation instruction is generated by the first e-mail box according to a click operation by a user, and instructs the establishment of an association between identifiers in the first Internet application.

At Step 702, the first acquisition module 502 acquires a first identifier and a second identifier in response to the first operation instruction, where the first identifier is an identifier of the first e-mail box, and the second identifier is an identifier of the second e-mail box communicated with the first e-mail box. For example, the first acquisition module 502 searches for a first identifier corresponding to the first e-mail box of the first communication party according to the first e-mail box, and searches for a second identifier corresponding to the second e-mail box of the second communication party according to the second e-mail box. The first identifier and the second identifier each may be an instant messenger account of a user, such as a QQ account, and may also be a Wechat account, a cellphone number and so on. In the present embodiment, the first identifier and the second identifier are QQ accounts corresponding to the e-mail boxes, for example.

At Step 703 (including Step 7031 and Step 7032), the first determination module 504 determines whether there is an association between the first identifier and the second identifier in the first Internet application and the second Internet application, respectively, and generates a determination result. The determination result includes three cases, i.e. a first case where an association is present between the first identifier and the second identifier in the first Internet application, a second case where an association is present between the first identifier and the second identifier in the second Internet application rather than in the first Internet application, and a third case where no association is present between the first identifier and the second identifier in either the first Internet application or the second Internet application.

At Step 704, the identifier association establishing module 503 establishes an association between the first identifier and the second identifier in the first Internet application according to the determination result.

At Step 705, the second display module 505 displays prompt information if the determination result shows that an association is present between the first identifier and the second identifier in the first Internet application, where the prompt information corresponds to the case that there is an association between the first identifier and the second identifier in the first Internet application, which is advantageous for enabling a user to be aware of the association between the first identifier and the second identifier in the first Internet application.

The identifier association establishing method according to an embodiment of the present invention can establish an association the two communication parties of the e-mail in other Internet applications (for example, establish a friend relationship in Wechat) based on the e-mail communication.

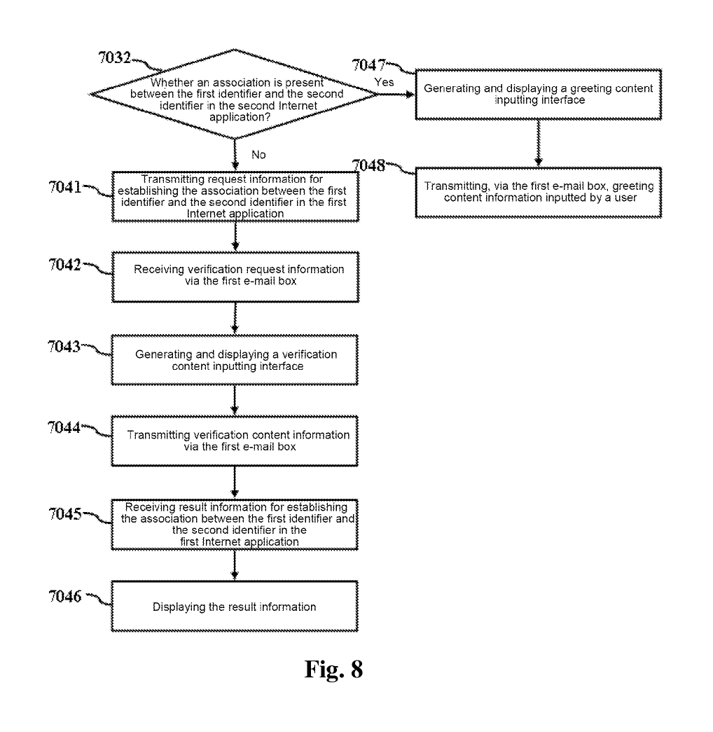

Reference is made to FIG. 8 which is a flowchart showing a step of establishing an association between the first identifier and the second identifier in the first Internet application.

In the identifier association establishing method according to the embodiment, the step (i.e. Step 704) that the identifier association establishing module 503 establishes an association between the first identifier and the second identifier in the first Internet application includes following Steps 7041, 7045 and 7046.

At Steps 7041 and 7045, if the determination result shows that an association is present between the first identifier and the second identifier in the second Internet application rather than in the first Internet application, the reception and transmission control module 5031 is configured for transmitting request information via the first e-mail box, with the request information being used for requesting the establishment of the association between the first identifier and the second identifier in the first Internet application; and is configured for receiving result information via the first e-mail box, with the result information being used for returning an result of the establishment of the association between the first identifier and the second identifier in the first Internet application. In particular, the reception and transmission control module 5031 transmits the request information to a server of the first Internet application via the first e-mail box and receives feedback information (i.e. result information) corresponding to the request information from the server of the first Internet application via the first e-mail box.

At Step 7046, the first display module 5033 displays the result information.

As an improvement for the above identifier association establishing method, Step 704 further includes the following Steps 7042, 7043 and 7044, after Step 7041 and before Step 7045.

At Step 7042, the reception and transmission control module 5031 further receives verification request information via the first e-mail box.

At Step 7043, the interface generation module 5032 generates and displays a verification content inputting interface.

At Step 7044, the reception and transmission control module 5031 further transmits, via the first e-mail box, verification content information inputted by a user.

In the present embodiment, the identifier association establishing module 503 transmits request information for establishing the association between the first identifier and the second identifier in the first Internet application to the server of the first Internet application, so as to establish the association between the first identifier and the second identifier in the first Internet application.

If no association is present between the first identifier and the second identifier in either the first Internet application or the second Internet application, Step 704 further includes the following Steps 7047 and 7048.

At Step 7047, the interface generation module 5032 further generates and displays a greeting content inputting interface.

At Step 7048, the reception and transmission control module 5031 further transmits, via the first e-mail box, greeting content information inputted by a user. In particular, the reception and transmission control module 5031 transmits the greeting content information to the server of the first Internet application via the first e-mail box. In the present embodiment, the identifier association establishing module 503 transmits the greeting content to an account corresponding to the second identifier in the first Internet application, so as to establish the association between the first identifier and the second identifier in the first Internet application.

In an embodiment of the present invention, a computer program configured for performing the above identifier association establishing method is stored in a computer storage medium, i.e. the computer program can include program instructions which cause a computer to perform the identifier association establishing function, and the function includes Steps 701 to 705 described as above.

Finally, it is noted that those skilled in the art can understand that all or part of processes in the above method of embodiments can be achieved through instructing related hardware by the computer program, with the computer program being stored in a computer readable storage medium. When executed, the computer program can include processes of embodiment of above method. The storage medium can be a magnetic disk, an optical disk, a read-only memory (ROM) or a random access memory (RAM) and so on.

Various function units in the embodiment of the present invention can be integrated into a processing module, or each of function units can be also physically separated individually, or two or more of the function units can be also integrated into one module. The integrated module can be implemented in a hardware form, or can be also implemented in a software function module form. If the integrated module is implemented in a software function module form and is sold or used as an individual product, then it can also be stored in a computer readable storage medium. The above mentioned storage medium can be a read-only memory, a magnetic memory or an optical disk and so on. Various devices or systems described above can execute methods in corresponding method embodiments.

From the above, the preferred embodiments of the present invention are described as above, but not intended to limit the present invention. Those skilled in the art can make various changes and modification without departing from the spirit and scope of the invention, thus the scope of the invention is defined by the appended claims.

### Implementation

N/A

### INDUSTRIAL APPLICABILITY

N/A

### Sequence Table Freedom Content

N/A

1. An association method for communication modes, comprising:
transmitting and receiving an e-mail between a first e-mail box and a second e-mail box;
acquiring a first identifier corresponding to the first e-mail box and a second identifier corresponding to the second e-mail box;
determining whether to associate the first identifier and the second identifier; and
associating the first identifier and the second identifier if it is determined to associate the first identifier and the second identifier.

2. The association method for communication modes of claim 1, comprising:
generating association prompt information and displaying the association prompt information for a user, if it is determined to associate the first identifier and the second identifier; and
establishing an association between the first identifier and the second identifier, when the association prompt information is accepted by the user.

3. The association method for communication modes of claim 2, further comprising:
transmitting verification information when the association prompt information is accepted by the user, receiving a verification result, and establishing the association between the first identifier and the second identifier if the verification result is correct; or
verifying the verification information when the verification information is received, and transmitting the verification result.

4. The association method for communication modes of claim 2, comprising:
if it is determined not to associate the first identifier and the second identifier, an association prompt module displays the association present between the first identifier and the second identifier.

5. The association method for communication modes of claim 1, further comprising:
transmitting and receiving an instant message between a first communication party and a second communication party; and
after the instant message is transmitted and received, establishing the association between the first identifier and the second identifier.

6. An association device for communication modes, comprising:
an e-mail reception and transmission module, which is configured for receiving and transmitting an e-mail between a first e-mail box and a second e-mail box;
a second acquisition module, which is configured for acquiring a first identifier corresponding to the first e-mail box and a second identifier corresponding to the second e-mail box;
a second determination module, which is configured for determining according to the first identifier and the second identifier whether to associate the first identifier and the second identifier; and
an association module, which is configured for associating, if it is determined by the second determination module to associate the first identifier and the second identifier, the first identifier with the second identifier.

7. The association device for communication modes of claim 6, wherein the association module comprises:
an association prompt module, which is configured for generating association prompt information and displaying the association prompt information for a user, if it is determined to associate the first identifier and the second identifier; and
an association establishment module, which is configured for establishing the association between the first identifier and the second identifier, when the association prompt information is accepted by the user.

8. The association device for communication modes of claim 7, wherein the association module further comprises:
a verification module, which is configured for transmitting verification information to a communication party in relation to the user when the association prompt information is accepted by the user and receiving a verification result, and is configured for verifying verification information when receiving the verification information and transmitting a verification result;
the association establishment module is further configured for establishing the association between the first identifier and the second identifier, if the verification result is correct.

9. The association device for communication modes of claim 7, wherein if it is determined not to associate the first identifier and the second identifier, the association prompt module is further configured for displaying the association present between the first identifier and the second identifier.

10. The association device for communication modes of claim 6, further comprising:
an instant message module, which is configured for receiving and transmitting the instant message between the first e-mail box and the second e-mail box;
the association establishment module is further configured for establishing, after the instant message is received and transmitted by the instant message module, the association between the first identifier and the second identifier.

11. An identifier association establishing method, comprising:
receiving a first operation instruction transmitted by a first e-mail box, wherein the first operation instruction is generated by the first e-mail box according to a click operation by a user, and the first operation instruction is configured for instructing establishment of an association between identifiers in a first Internet application;
acquiring a first identifier and a second identifier in response to the first operation instruction, wherein the first identifier is an identifier of the first e-mail box, and the second identifier is an identifier of the second e-mail box in communication with the first e-mail box; and
establishing an association between the first identifier and the second identifier in the first Internet application.

12. The identifier association establishing method of claim 11, wherein after the acquiring a first identifier and a second identifier, and before the establishing an association between the first identifier and the second identifier in the first Internet application, the method further comprises:
determining whether an association is present between the first identifier and the second identifier in the first Internet application and a second Internet application, respectively, and generating a determination result.

13. The identifier association establishing method of claim 12, wherein if the determination result shows that the association is present between the first identifier and the second identifier in the second Internet application rather than in the first Internet application, the establishing an association between the first identifier and the second identifier in the first Internet application comprising:
transmitting request information via the first e-mail box, with the request information being configured for requesting to establish the association between the first identifier and the second identifier in the first Internet application;
receiving result information via the first e-mail box, with the result information being configured for returning an result of the establishment of the association between the first identifier and the second identifier in the first application; and
displaying the result information.

14. The identifier association establishing method of claim 13, wherein after the transmitting request information via the first e-mail box and before the receiving result information via the first e-mail box, the establishing an association between the first identifier and the second identifier in the first application Internet application further comprises:
receiving verification request information via the first e-mail box;
generating and displaying a verification content inputting interface; and
transmitting verification content information inputted by a user via the first e-mail box.

15. The identifier association establishing method of claim 12, wherein if the determination result shows that no association is present between the first identifier and the second identifier in either the first Internet application or the second Internet application, the establishing an association between the first identifier and the second identifier in the first Internet application comprises:
generating and displaying a greeting content inputting interface; and
transmitting greeting content information inputted by a user via the first e-mail box.

16.-20. (canceled)
